(19) United States
(12) Patent Application Publication
(10) Pub. No.: US 2015/0140867 A1
(43) Pub. Date: May 21, 2015

(54) POWER PLUG EXTENDER

(71) Applicant: Liang Light Chen, Los Gatos, CA (US)

(72) Inventor: Liang Light Chen, Los Gatos, CA (US)

(21) Appl. No.: 14/082,013

(22) Filed: Nov. 15, 2013

(51) Int. Cl. H01R 31/06

(52) U.S. Cl. CPC H01R 31/06
USPC 439/651

(57) ABSTRACT

A power plug extender includes a bottom three-pin plug portion and a top three-pin plug receptacle portion. The top power plug receptacle portion is rotated to have a rotational offset angle between thirty degrees and sixty degrees with respect to the bottom plug portion.

### BACKGROUND

Many electronic devices use power adapters that are relatively bulky compared to a typical size power output. A power strip may have, for example, four, six or eight outlet plugs. However, the spacing of the outlet plugs may be such that attaching a single power adapter into one outlet plug may make one or more of the other outlet plugs unavailable because these other outlet plugs are partially covered or crowded by the single power adapter. Short extension cords, with or without pass-through, have been used to spread out the location of outlet plugs to allow for more efficient use of the outlet plugs on power strips.

### BRIEF DESCRIPTION OF DRAWINGS

FIG. 1 shows six power plug extenders with offset pass-throughs plugged into a power strip in accordance with an embodiment.

FIG. 2 shows three power plug extenders with offset pass-throughs plugged into the power strip shown in FIG. 1 in accordance with an embodiment.

FIG. 3 shows three power plug extenders with offset pass-throughs plugged into another power strip in accordance with an embodiment.

FIG. 4 shows a top view of a power plug extender with offset pass-through in accordance with an embodiment.

FIG. 5 shows a bottom view of a power plug extender with offset pass-through in accordance with an embodiment.

FIG. 6 shows a top front left perspective view of a power plug extender with offset pass-through in accordance with an embodiment.

FIG. 7 and FIG. 8 shows arrangement of metal portions within a power plug extender with offset pass-through plugged into a power strip in accordance with an embodiment.

### DETAILED DESCRIPTION

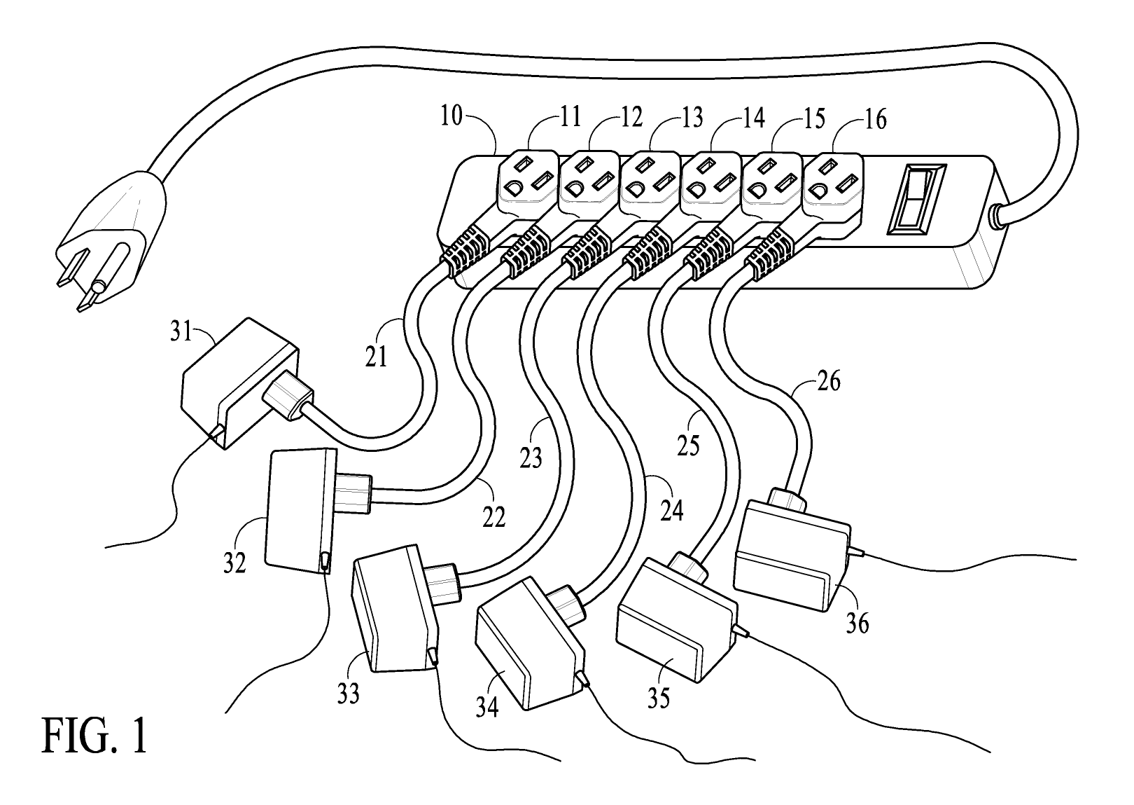

FIG. 1 shows a power plug extender with offset pass-through 11, a power plug extender with offset pass-through 12, a power plug extender with offset pass-through 13, a power plug extender with offset pass-through 14, a power plug extender with offset pass-through 15 and a power plug extender with offset pass-through 16 plugged into a power strip 10.

Power plug extender with offset pass-through 11 includes a power plug extender section 21 having a power plug receptacle into which is plugged an adapter 31. Power plug extender with offset pass-through 12 includes a power plug extender section 22 having a power plug receptacle into which is plugged an adapter 32. Power plug extender with offset pass-through 13 includes a power plug extender section 23 having a power plug receptacle into which is plugged an adapter 33. Power plug extender with offset pass-through 14 includes a power plug extender section 24 having a power plug receptacle into which is plugged an adapter 34. Power plug extender with offset pass-through 15 includes a power plug extender section 25 having a power plug receptacle into which is plugged an adapter 35. Power plug extender with offset pass-through 16 includes a power plug extender section 26 having a power plug receptacle into which is plugged an adapter 36.

While FIG. 1 shows each extender having an extension cord with a power plug receptacle into which is plugged an adapter, this is only illustrative. Any of the extension cords may, instead of the shown receptacle, include for example, a power receptacle having any shape or size, or even a power strip with multiple receptacles. Alternatively, the extension cord may be directly connected to equipment requiring power to operate.

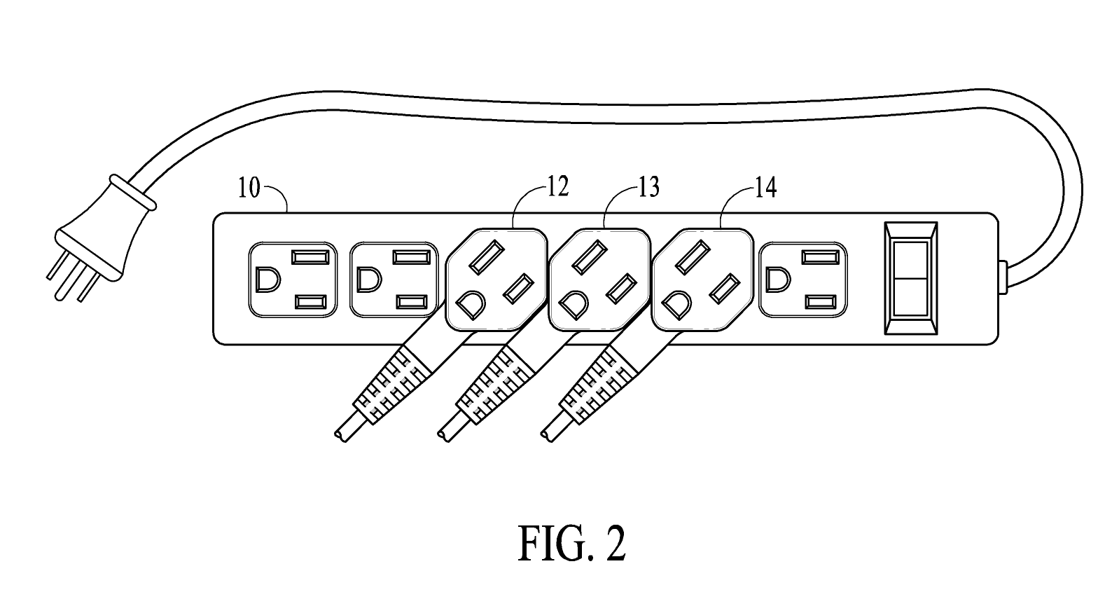

FIG. 2 shows the result when power plug extender with offset pass-through 11, power plug extender with offset pass-through 15 and power plug extender with offset pass-through 16 are removed from power strip 10.

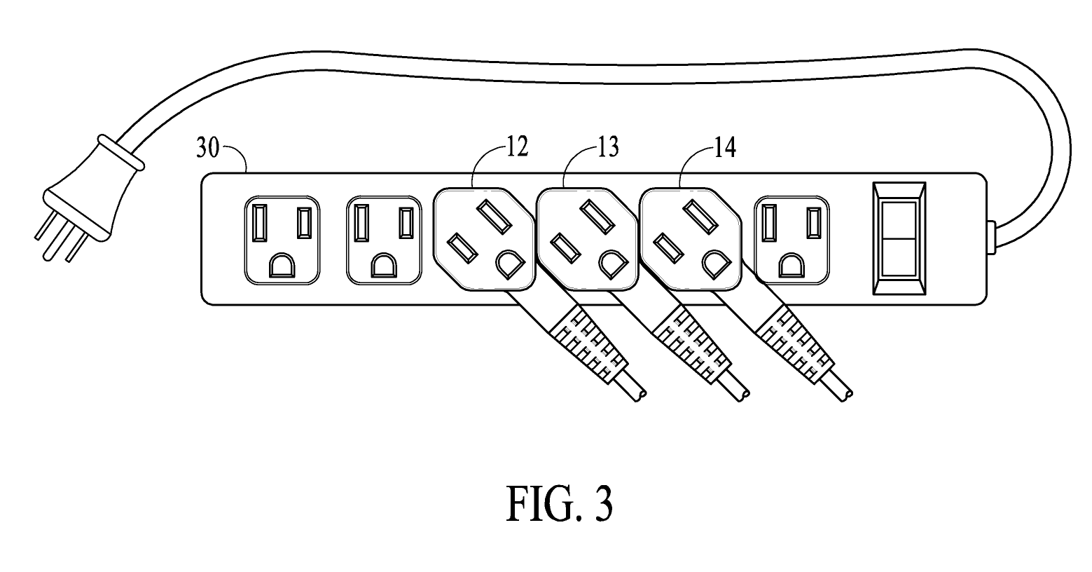

FIG. 3 shows the result when power plug extender with offset pass-through 12, power plug extender with offset pass-through 13 and power plug extender with offset pass-through 14 are plugged into a power strip 30. Notice that the six power outlets in power strip 30 are ninety degrees offset from the orientation of the six power outlets in power strip 10 shown in FIG. 2. Despite the 90 degree rotation, power plug extender with offset pass-through 12, power plug extender with offset pass-through 13 and power plug extender with offset pass-through 14 fit on adjacent power outlets of both power strip 10 and power strip 30.

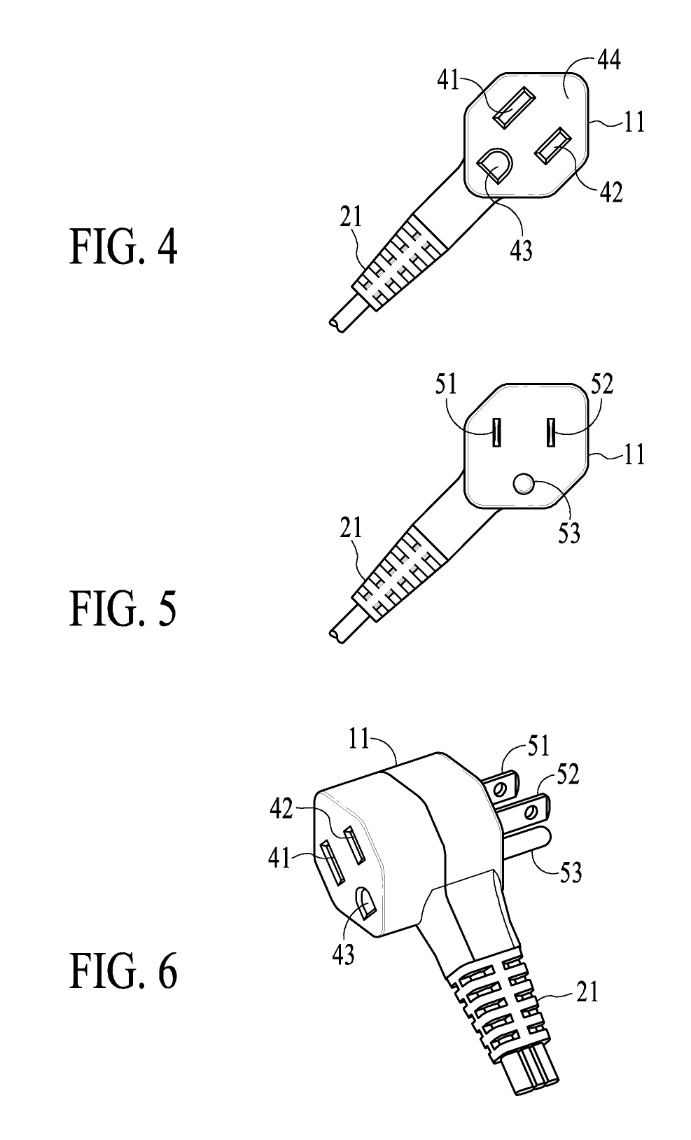

FIG. 4 shows a top view of power plug extender with offset pass-through 11. At the top of power plug extender is a power plug receptacle including an AC pin receptacle 41, an AC pin receptacle 42 and a ground pin 43. An obstruction region 44 prevents a three-pin plug from being plugged into power plug extender with offset pass-through 11 in a wrong orientation. If this were attempted, the ground pin of the three-pin plug would be obstructed by obstruction region 44. The result is that AC pins of a three-pin plug can only be plugged into AC pin receptacle 41 and AC pin receptacle 42 in a proper orientation.

While obstruction region 44 is desirable, the inclusion of obstruction region 44 as part of power plug extender with offset pass-through 11 means that without an offset, only three extender chords could be mounted on power strip 10. The inclusion of obstruction region 44 as part of and power plug extender with pass-through would simply make the power plug extender with pass-through too long to fit six such power plug extender with pass-through onto single power strip 10.

To solve this and allow six power plug extenders with pass-throughs to be placed onto power strip 10, the orientation of the pass through has been offset (i.e., rotated) approximately within range of 30 degrees to 60 degrees. If the orientation is offset a full ninety degrees then, for example, this would prevent six power plug extenders with pass-throughs to be placed onto power strip 30.

An offset of approximately within range of 30 degrees to 60 degrees allows allow six power plug extenders with pass-throughs to be placed onto either power strip 10 or power strip 30.

FIG. 5 shows a bottom view of power plug extender with offset pass-through 11. Notice the position of cord 21 with respect to an AC pin 51, an AC pin 52 and a ground pin 53. When compared to FIG. 4, AC pin 51, AC pin 52 and ground pin 53 are offset about forty-five degrees from AC pin receptacle 41, AC pin receptacle 42 and ground pin 43, respectively. While the offset in power plug extender with offset pass-through 11 is approximately forty-five degrees, this is only illustrative. Any offset within an approximate range of 30 degrees to 60 degrees may work.

FIG. 6 is a top front left perspective view of power plug extender with offset pass-through 11 which shows the offset of AC pin 51, AC pin 52 and ground pin 53 from AC pin receptacle 41, AC pin receptacle 42 and ground pin 43, respectively.

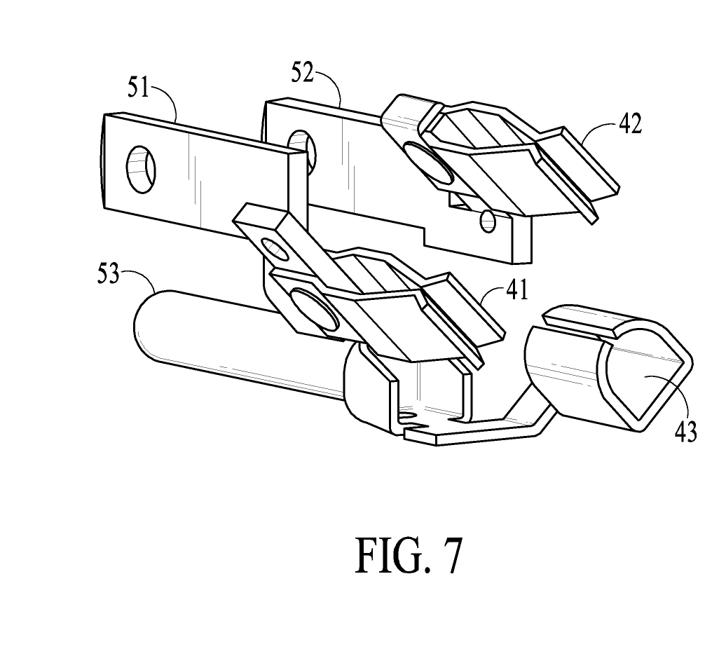

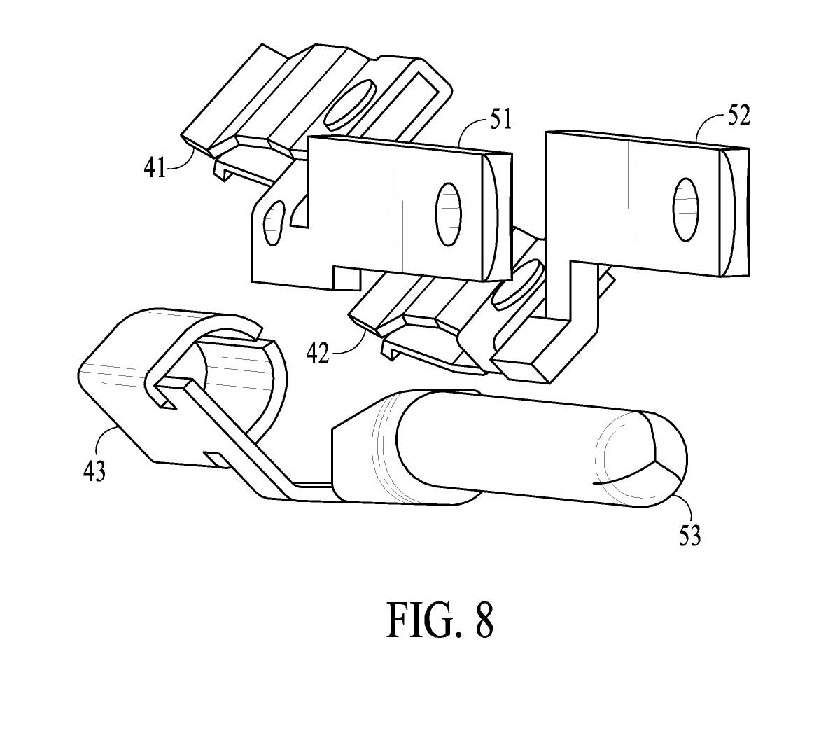

FIG. 7 and FIG. 8 shows arrangement of AC pin 51, AC pin 52 ground pin 53, AC pin receptacle 41, AC pin receptacle 42 and ground pin 43 within a power plug extender with offset pass-through 11. In this conceptual drawing, insulated portions of power plug extender with offset pass-through 11 are removed so it can be seen how within power plug extender with offset pass-through 11 AC pin 51, AC pin 52 and ground pin 53 are respectively connected to AC pin receptacle 41, AC pin receptacle 42 and ground pin 43. AC pin receptacle 41 and AC pin receptacle 41 are each shown implemented by a clip.

The foregoing discussion discloses and describes merely exemplary methods and implementations. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed is:

1. A power plug extender, comprising:
a bottom plug portion, out of which extend:
a first alternating current (AC) pin,
a second AC pin, and
a ground pin;
a top power plug receptacle portion, including:
a first AC pin receptacle,
a second AC pin receptacle, and
a ground pin receptacle; and,
a power plug extender section having a power plug receptacle;
wherein the top power plug receptacle portion is rotated to have an offset angle between thirty degrees and sixty degrees with respect to the bottom plug portion so that the first AC pin, the second AC pin and the ground pin are respectively offset at a rotational offset angle of between thirty degrees and sixty degrees from the first AC pin receptacle, the second AC pin receptacle and the ground pin receptacle.

2. A power plug extender as in claim 1 wherein the top power plug receptacle portion additionally includes:
an obstruction region that prevents a three pin plug from being plugged into top power plug receptacle portion in a wrong orientation.

3. A power plug extender as in claim 1 wherein the offset angle is forty-five degrees and the rotational offset angle is forty-five degrees.

4. A power plug extender, comprising:
a bottom plug portion, out of which extend:
a first alternating current (AC) pin,
a second AC pin, and
a ground pin;
a top power plug receptacle portion, including:
a first AC pin receptacle,
a second AC pin receptacle, and
a ground pin receptacle; and,
wherein the top power plug receptacle portion is rotated to have a rotational offset angle between thirty degrees and sixty degrees with respect to the bottom plug portion so that the first AC pin, the second AC pin and the ground pin are respectively offset at the rotational offset angle of between thirty degrees and sixty degrees from the first AC pin receptacle, the second AC pin receptacle and the ground pin receptacle.

5. A power plug extender as in claim 4 wherein the top power plug receptacle portion additionally includes:
an obstruction region that prevents a three pin plug from being plugged into top power plug receptacle portion in a wrong orientation.

6. A power plug extender as in claim 4 additionally comprising:
an extension cord.

7. A power plug extender as in claim 4 wherein the rotational offset angle is forty-five degrees.

8. A method for providing power plug extension, comprising:
providing a bottom portion of the power plug extension that includes a first alternating current (AC) pin, a second AC pin, and a ground pin;
providing a top power plug receptacle portion that includes a first AC pin receptacle, a second AC pin receptacle, and a ground pin receptacle; and
rotating the top power plug receptacle portion to have a rotational offset angle between thirty degrees and sixty degrees with respect to the bottom plug portion so that the first AC pin, the second AC pin and the ground pin are respectively offset at the rotational offset angle of between thirty degrees and sixty degrees from the first AC pin receptacle, the second AC pin receptacle and the ground pin receptacle.

9. A method as in claim 8 additionally comprising:
providing as part of the power plug extension an extension cord with a three-pin power plug receptacle.

10. A method as in claim 8 additionally comprising:
providing as part of the top power plug receptacle portion an obstruction region that prevents a three pin plug from being plugged into top power plug receptacle portion in a wrong orientation.

11. A method as in claim 8 wherein the rotational offset angle is forty-five degrees.
